(19) United States
(12) Patent Application Publication
(10) Pub. No.: US 2025/0190390 A1
(43) Pub. Date: Jun. 12, 2025

(54) SYNCHRONIZATION OF STREAMING DATA BETWEEN TWO PERIPHERAL COMPONENT INTERCONNECT EXPRESS (PCIE) DEVICES

(71) Applicant: NVIDIA Corporation, Santa Clara, CA (US)

(72) Inventor: Amit Parikh, Santa Clara, CA (US)

(21) Appl. No.: 18/434,221

(22) Filed: Feb. 6, 2024

Related U.S. Application Data
(60) Provisional application No. 63/608,131, filed on Dec. 8, 2023.

(51) Int. Cl. G06F 13/42; G06F 13/28

(52) U.S. Cl. CPC G06F 13/423; G06F 13/28; G06F 2213/0026; G06F 2213/28

(57) ABSTRACT

Apparatuses, systems, and techniques for streaming data to client devices using a data processing unit (DPU) or other Peripheral Component Interconnect Express (PCIe) device. One computing system includes a central processing unit (CPU), a first PCIe device, a second PCIe device, and a hardware synchronization mechanism to synchronize streaming data from the first PCIe device to the second PCIe device without involvement by the CPU.

### RELATED APPLICATIONS

This application claims the benefit of U.S. Application No. 63/608,131, filed Dec. 8, 2023, the entire contents of which are incorporated by reference.

### TECHNICAL FIELD

At least one embodiment pertains to processing resources used to perform and facilitate operations for synchronizing streaming data from a first Peripheral Component Interconnect Express (PCIe) device to a second PCIe device without involvement by a central processing unit (CPU). For example, at least one embodiment pertains to processors or computing systems used to provide synchronization and data handling between a graphics processing unit (GPU) and a data processing unit (DPU) for using the DPU in a streaming pipeline for a game streaming scenario, according to various novel techniques described herein.

### BACKGROUND

Data centers with high-performance GPUs can be used to stream games to client devices. A gaming server can include one or more CPUs and one or more GPUs. A CPU can execute a game and a GPU can handle some demanding tasks of running the game. These servers are responsible for rendering the game's graphics, processing user inputs, and executing game logic in real-time.

Once the game is rendered, the video output is captured and compressed to reduce its size for efficient transmission. This compressed video stream, along with audio and other game data, is then sent over the internet from the data center to the client device. This transmission involves traversing through the data center's internal network and the wider internet, facilitated by Internet Service Providers (ISPs). The journey of the data includes routing through various networks and potentially being cached by Content Delivery Networks (CDNs) to minimize latency and enhance the streaming quality.

When the data reaches the client's ISP, it is then directed to the client's device, such as a gaming console, computer, or even a mobile device. The client device receives the streamed data, decompresses the video and audio, and presents it to the player. The device also captures the player's inputs (like controller or keyboard commands) and sends these back to the server in the data center, where they are processed to update the game state. This two-way communication between the client device and the data center is essential for interactive gameplay.

Throughout this process, specialized streaming protocols and technologies are used to ensure that the game stream is smooth, responsive, and of high visual quality. These technologies work to minimize latency, packet loss, and other factors that could affect the gaming experience. The quality of the game streaming is influenced by the performance of the CPUs and GPUs in the data center, the efficiency of the data compression and decompression techniques, the speed and reliability of the internet connection, and the capabilities of the client device.

### BRIEF DESCRIPTION OF DRAWINGS

Various embodiments in accordance with the present disclosure will be described with reference to the drawings, in which:

FIG. 1 is a block diagram of a computing system with a CPU, a first PCIe device, and a second PCIe device with a hardware synchronization mechanism according to at least one embodiment.

FIG. 2 is a block diagram of an example DPU-based system architecture with a hardware synchronization mechanism for synchronizing direct memory access (DMA) transfers of video bitstreams from a GPU-mapped system memory buffer to a memory of a DPU without involvement of a CPU, according to at least one embodiment.

FIG. 3 is a block diagram of a game server using a DPU in a streaming pipeline for game streaming scenarios according to at least one embodiment.

FIG. 4A is a block diagram of a streaming pipeline without a DPU according to at least one embodiment.

FIG. 4B is a block diagram of a streaming pipeline with a DPU according to at least one embodiment.

FIG. 5 is a block diagram of GPU software and DPU software for synchronizing streaming data according to at least one embodiment.

FIG. 6 is a block diagram of software of a client, an operating system of a virtual machine, and DPU software according to at least one embodiment.

FIG. 7 is a flow diagram of an example method of streaming game data using a DPU according to at least one embodiment.

FIG. 8 is a flow diagram of an example method of streaming data between a first PCIe device and a second PCIe device according to at least one embodiment.

### DETAILED DESCRIPTION

Data center security includes a wide range of technologies and solutions to stream data to client devices. A data center is a facility that stores different devices such as switches, routers, load balancers, firewalls, servers, networked computers, storage, network interface cards (NICs), CPUs, DPUs, GPUs, and other resources as part of the information technology (IT) infrastructure. For private companies moving to the cloud, data centers reduce the cost of running their own centralized computing networks and servers. Data centers provide services, such as storage, backup and recovery, data management, networking, security, orchestration, or the like. Data centers are complex and include many types of devices and services. GPUs have become a key part of modern supercomputing, including hyperscale data centers. GPUs have become accelerators speeding up all sorts of tasks from encryption to networking to artificial intelligence (AI). While GPUs are now about a lot more than the personal computers (PCs) in which they first appeared, GPUs are powerful for their parallel computing capability. CPUs remain essential, providing fast and versatile capabilities to perform a series of tasks requiring lots of interactivity. By contrast, GPUs break complex problems into thousands or millions of separate tasks and work them out at once. That makes them ideal for graphics, where textures, lighting and the rendering of shapes have to be done at once to keep images flying across the screen. A CPU can have several cores that are good for serial processing with low latency and can perform a handful of operations at once. For comparison, a GPU can have many cores that are good for parallel processing with high throughput and can perform thousands of operations at once. Architecturally, the CPU is composed of just a few cores with lots of cache memory that can handle a few software threads at a time. In contrast, a GPU is composed of hundreds of cores that can handle thousands of threads simultaneously. GPUs deliver the technology of parallel computing in desktops, gaming consoles, and data centers. GPUs offers a way to continue accelerating applications—such as graphics, supercomputing and AI—by dividing tasks among many processors. GPUs perform much more work for every unit of energy than CPUs. That makes them key to supercomputers that would otherwise push past the limits of today's electrical grids. In AI, GPUs have become key to a technology called “deep learning.” Deep learning pours vast quantities of data through neural networks, training them to perform tasks too complicated for any human coder to describe. That deep learning capability is accelerated thanks to the inclusion of dedicated Tensor Cores in NVIDIA GPUs. Tensor Cores accelerate large matrix operations, at the heart of AI, and perform mixed-precision matrix multiply-and-accumulate calculations in a single operation. That not only speeds traditional AI tasks of all kinds, but it is also now being tapped to accelerate gaming. In the automotive industry, GPUs offer many benefits. They provide unmatched image recognition capabilities, as you would expect. But they are also key to creating self-driving vehicles able to learn from—and adapt to—a vast number of different real-world scenarios. In robotics, GPUs are key to enabling machines to perceive their environment, as you would expect. Their AI capabilities, however, have become key to machines that can learn complex tasks, such as navigating autonomously. In healthcare and life sciences, GPUs offer many benefits. They are ideal for imaging tasks, of course. But GPU-based deep learning speeds the analysis of those images. They can crunch medical data and help turn that data, through deep learning, into new capabilities. In short, GPUs have become essential. They began by accelerating gaming and graphics. Now they are accelerating more areas where computing horsepower will be effective.

Conventionally, in a game streaming scenario, a CPU executes a game and offloads game rendering to a GPU before the CPU streams the data to a client device over a network. The GPU can encode a video bitstream using GPUs encoding engine. The video bitstream can be stored in GPU memory (also called video memory). The driver and lower-level components of the GPU make a copy of the encoded bitstream from the video memory into system memory for further processing by the CPU before being sent to the client device over the network using a NIC or a DPU. A DPU, such as the BlueField SmartNIC, is an embedded system on a chip (SoC) that can be used to offload network operations. The DPU can be a programmable data center infrastructure on a chip. The DPU can have hardware engines and embedded processor cores (e.g., ARM cores). Sending the encoded video back to the CPU for further processing causes additional latency. The further processing after encoding also takes away from processing the game. Also, with a virtualized GPU, the GPU's resources can be dedicated to multiple streams. These streams need to run the above-mentioned network stack on the CPU which can add up, as well as in some cases cause additional latency. In extreme scenarios, where lot of streams are being run on a virtualized CPU and GPU, there can be scheduling issues by an operating system (OS) thread, possibly causing gaps in streaming the data, which may further cause latency and Quality of Service (QOS) problems.

Aspects and embodiments of the present disclosure address the above and other deficiencies by providing a hardware synchronization mechanism that synchronizes a video bitstream from the GPU and a DPU without involvement of the CPU, where the DPU can perform the additional processing on the video bitstream before sending to a client device over a network. The CPU can execute a game application to be streamed to the client device over the network. The GPU can render frames of the game application and encode a video bitstream of the rendered frames and store the video bitstream in a GPU-mapped system member buffer (i.e., a buffer in system memory). The DPU can synchronize DMA transfers of the video bitstream from the GPU-mapped system memory buffer to memory of the DPU without involvement of the CPU. The DPU can send video bitstream to the client device over the network. The embedded cores of the DPU can perform serialized CPU-like operations, which are typically performed by the CPU in a typical game streaming scenario. The hardware synchronization mechanism can allow synchronization between the GPU and DPU such that DPU picks up the processing the moment the GPU is done encoding of the video stream without creating additional copies of the data. The hardware synchronization mechanism can perform buffer handling such that the GPU knows when a buffer is done so that the buffer can be put back in the queue for use by subsequent frames. The hardware synchronization mechanism can be implemented via GPU backend semaphores that get released by video engines and making the mapping of GPU-mapped system memory buffers available to the DPU for DMA transfers. Since the DPU can be a PCIe device, the GPU-mapped system memory buffer can be mapped to the DPU and the DPU can access system memory. In this manner, the DPU can read the bitstream and write into its onboard memory for further processing. Similarly, the semaphore memory is mapped to the DPU. The DPU can poll that memory at a specified frequency (e.g., 100 nanoseconds) or can use hardware synchronization techniques to look at the semaphore memory and raise an interrupt to initiate a DMA transfer from system memory to onboard memory, such that the DMA does not add any latency. Once the DMA transfer is complete, the DPU can use its own buffer copy for further network processing or offloading. The DPU can notify the GPU via events or software callbacks, to put the buffer used for the video bitstream back into the queue. Doing this can reduce the CPU workload by moving all processing after video rendering and encoding to the DPU, keeping the CPU resources for executing the game. By using hardware semaphores and hardware synchronization, the latency reduces as well. Being a network processor that processes the network operations, the DPU can accelerate via packet pacing or other offload engines, hence reducing total processing time and improving QoS. Another benefit of the DPU handling the processing after the video rendering and encoding is a VM can be isolated as the client only connects to the DPU endpoint.

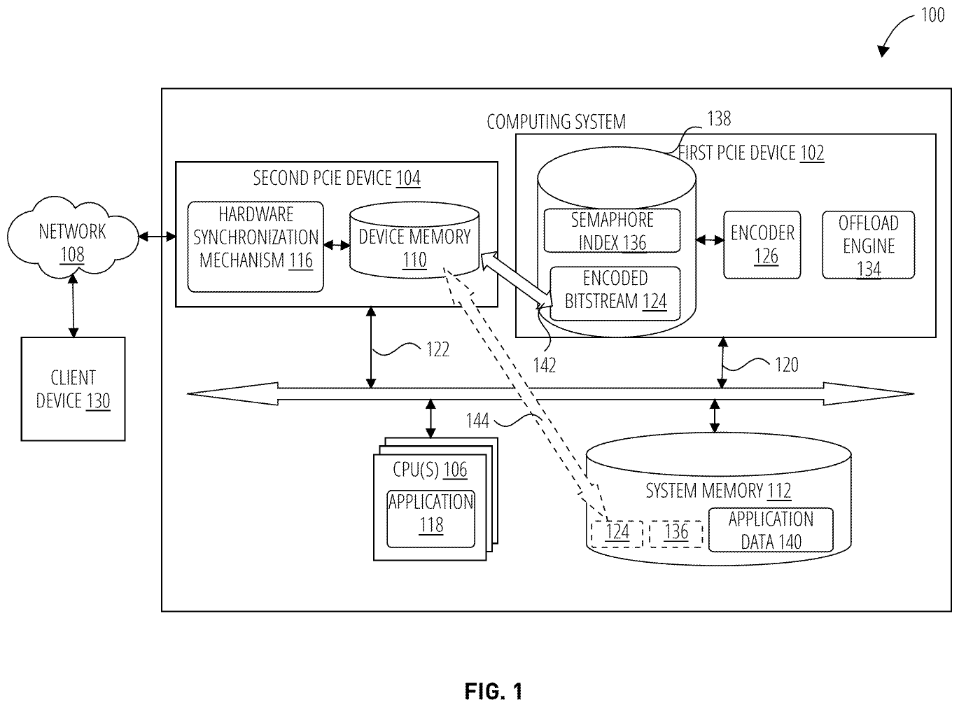

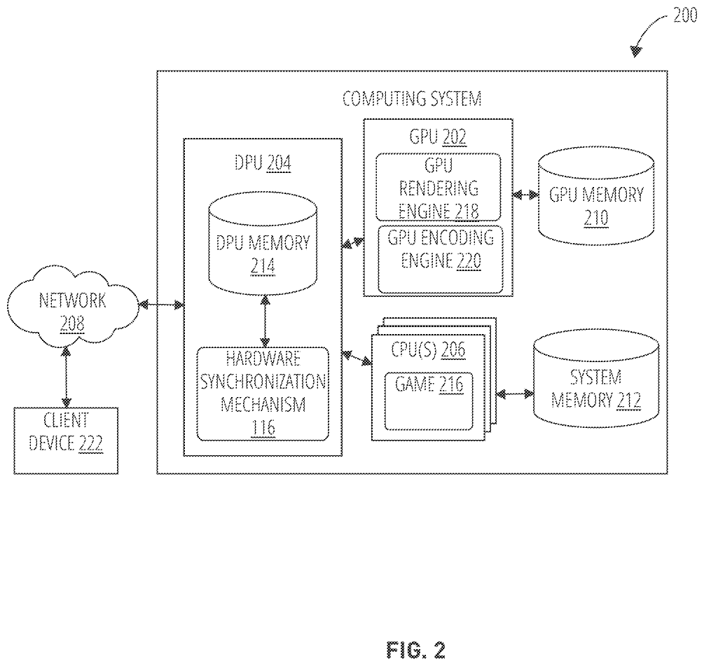

Aspects and embodiments of the present disclosure can use the hardware synchronization mechanism more generally between a first Peripheral Component Interconnect Express (PCIe) device and a second PCIe device to synchronize streaming data from the first PCIe device to the second PCIe device without involvement by a CPU coupled to both the first and second PCIe devices. An example of a computing system with a hardware synchronization mechanism between two PCIe devices is described below with respect to FIG. 1, whereas an example of a computing system with a hardware synchronization mechanism between a GPU and a DPU is described below with respect to FIG. 2.

FIG. 1 is a block diagram of a computing system 100 with a CPU 106, a first PCIe device 102, and a second PCIe device 104 with a hardware synchronization mechanism 116 according to at least one embodiment. The first PCIe device 102 is coupled to the CPU 106 via a PCIe interconnect 120. The second PCIe device 104 is coupled to the CPU 106 via a PCIe interconnect 122. The CPU 106 can execute an application 118 that generates application data 140. The CPU 106 can offload processing operations on the application data 140 to the first PCIe device 102. The first PCIe device 102 can include an offload engine 134 and an encoder 126. The offload engine 134 can perform the processing operations on the application data 140. Since the application data 140 is to be streamed to a client device 130 over a network 108, the encoder 126 can encode the application data 140 into an encoded bitstream 124 in device memory 138. The device memory 138 can be onboard memory of the first PCIe device 102. Alternatively, the device memory 138 can be memory coupled to the first PCIe device 102. The hardware synchronization mechanism 116 can retrieve the encoded bitstream 124 using a DMA transfer 142 when the encoded bitstream 124 is identified as being ready using a semaphore index 136. The hardware synchronization mechanism 116 can determine when encoded bitstream 124 is available for the DMA transfer 142 and a size of the DMA transfer. The hardware synchronization mechanism 116 can initiate the DMA transfer 142 to retrieve the encoded bitstream 124 from the first PCIe device 102 when a semaphore index 136 (or other synchronization indication) is enabled. The semaphore index 136 can be an entry in the semaphore memory. In general, semaphore memory refers to one or more memory locations where one or more semaphore values are stored. Semaphores can be used for controlling access to a common resource by multiple processes or threads, i.e., a thread in the DPU 204 and a thread in the GPU 202. A semaphore is a variable or an abstract data type that facilitates the management of access to shared resources by multiple threads, thus preventing critical section problems in a concurrent system. The primary purposes of semaphores are mutual exclusion and synchronization. Mutual exclusion prevents more than one process or thread from accessing the memory buffer, while synchronization coordinates the execution or access order by the threads or processes, ensuring that the DPU 204 waits until the GPU 202 has completed its tasks. There are two main types of semaphores: binary and counting. Binary semaphores act as locks and have only two values, 0 (locked) or 1 (unlocked), indicating the availability of a resource. Counting semaphores, on the other hand, can take on values greater than 1, allowing multiple instances of a resource to be accessed by a corresponding number of processes. Semaphore operations include the wait (P operation), where a process decreases the semaphore's value to access a resource, and the signal (V operation), where the process increases the semaphore's value after using the resource, signaling its availability. The term “semaphore completion” often refers to the scenario where a semaphore operation (usually the signal or V operation) is successfully executed, indicating the completion of a process's or thread's use of a shared resource. The semaphore completion, as described herein, refers to the successful encoding by the GPU encoding engine 220, particularly the release (or signal) of the semaphore, signifying that the GPU encoding engine 220 has completed its use of the memory buffer or has reached a certain point in its execution, allowing the DPU 204 to proceed with subsequent processing of the encoded bitstream.

In at least one embodiment, the first PCIe device 102 can have multiple memory buffers that are mapped to the second PCIe device 104. The multiple buffers can operate in a round-robin fashion. For example, there can be a set of available buffers that are not currently being used in a queue. The encoder 126 can use one of the available buffers to encode a bitstream. Once the buffer is no longer in use, it can be added back to the queue for reuse by the encoder 126. When encoding a bitstream of the application data 140, the encoder 126 can store the encoded bitstream 124 into the buffer, mapped to the second PCIe device 104. The encoder 126 can also store a semaphore index 136 associated with the encoded bitstream 124. The semaphore index 136 can specify what buffer is to be transferred to device memory 110 of the second PCIe device 104 when ready. The device memory 110 can be onboard memory of the second PCIe device 104. Alternatively, the device memory 110 can be memory coupled to the second PCIe device 104. The semaphore index 136 can increment in a round-robin fashion as well. The hardware synchronization mechanism 116 can periodically poll the semaphore memory to see if the semaphore index 136 is enabled. When the hardware synchronization mechanism 116 sees the semaphore index 136 enabled, the hardware synchronization mechanism 116 can initiate the DMA transfer 142 of the encoded bitstream 124 to the device memory 110. The second PCIe device 104 can perform additional processing on a copy of the encoded bitstream 124 that is stored in in device memory 110 before streaming the encoded bitstream 124 to the client device 130 over the network 108. In this manner, the hardware synchronization mechanism 116 can synchronize streaming data from the first PCIe device 102 to the second PCIe device 104 without involvement by the CPU 106. In some embodiments, there can be more than one CPU in the computing system 100. The CPU(s) 106 can be coupled to the PCIe devices using a first bus and coupled to the system memory 112 using a second bus. In another embodiments, as illustrated in FIG. 1, the CPU(s) 106, first PCIe device 102, second PCIe device 104, and system memory 112 can be coupled to a single bus. In at least one embodiment, the network 108 can include a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, and/or a combination thereof.

In another embodiment, the encoder 126 can store the encoded bitstream 124 in a system memory buffer of the system memory 112. The memory buffer of the system memory 112 and the semaphore index 136 can be memory mapped to the second PCIe device 104 as described above. The semaphore index 136 can also be stored and updated in the system memory 112 by the first PCIe device 102. The hardware synchronization mechanism 116 can periodically poll the semaphore index 136 in the system memory 112 to determine whether to initiate a DMA transfer between the system memory buffer in the system memory 112 and the device memory 110 in the second PCIe device 104. A mapped memory buffer is a segment of memory (or virtual memory) that has been specifically allocated to establish a direct byte-for-byte correlation with a portion of a file or a file-like resource, typically used in memory-mapped files or memory-mapped I/O. The GPU-mapped system memory buffer can facilitate inter-device communication between the GPU 202 and the DPU 204. The core idea behind memory-mapping is to map the contents of physical memory (e.g., memory buffer) of the GPU 202 into a memory space of the DPU 204. This mapping allows the data to be accessed as if it were part of the DPU's memory space. In computing, a buffer is a region of physical memory storage used for temporarily holding data during its transfer between locations. In the context of mapped memory buffers, this buffer represents a part of virtual memory assigned to a memory-mapped file. This approach to file I/O, as opposed to traditional read/write methods, allows applications to manipulate files directly in memory, enhancing performance by reducing system calls and data copying operations. It is particularly effective for streaming data, providing high-speed access and the ability to handle files with the simplicity of pointer operations.

In at least one embodiment, the computing system 100 reside in a data center and the second PCIe device 104 is a networking device, an infrastructure device, or the like that performs a networking function, such as the functions performed by hubs, repeaters, switches, routers, bridges, gateways, modems, or network interfaces. Examples of network devices can include, but are not limited to, access points, routers, Wi-Fi® access points, Wi-Fi® routers, switches, hubs, bridges, modems, DPUs, SmartNICs, active cables, or the like. In at least one embodiment, the second PCIe device 104 operates on one or more layers of the open systems interconnection (“OSI”) model. For example, the second PCIe device 104 may, in some cases, correspond to a hub that connects computing devices operating at level one of the OSI model. In another embodiment, the second PCIe device 104 is a bridge or switch that processes traffic at OSI layer two. In another embodiment, the second PCIe device 104 is a router operating at OSI layer three. In some embodiments, the second PCIe device 104 operates at multiple OSI levels.

In at least one embodiment, the operation of second PCIe device 104 at a layer of the OSI model comprises performing networking functions related to that layer. In at least one embodiment, the second PCIe device 104 can include circuitry and other computing facilities, such as processors, memory, and processor-executable instructions used to perform one or more network-related functions of the computing system 100, such as sending or receiving data to or from the client device 130. In some cases, the second PCIe device 104 can send or receive data between two devices. These devices can be physical devices or virtualized devices. This networking function may comprise sending or receiving data between a first host device and a second host device. In at least one embodiment, the second host device is considered a source host, and the first host device can be considered a destination host. A source host may be a device, such as a computing device that transmits data over a network. Similarly, a destination host may be a device, such as a computing device that receives data sent over the network.

In at least one embodiment, the first PCIe device 102 can map a system memory buffer and a semaphore memory to the second PCIe device. The second PCIe device 104 can poll the semaphore memory periodically. The second PCIe device 104 can raise an interrupt to initiate a DMA transfer of the streaming data from the system memory buffer to a memory of the second PCIe device. Once the DMA transfer is complete, the second PCIe device 104 can notify the first PCIe device that the DMA transfer is complete via an event or software callback. The second PCIe device 104 can perform operations, such as networking operations encryption operations, or the like.

In at least one embodiment, the first PCIe device 102 is a DPU, and the second PCIe device 104 is a GPU. The GPU can store a video bitstream in a GPU buffer mapped to the DPU. The GPU can map a semaphore memory to the DPU. The DPU can poll the semaphore memory periodically. The DPU can raise an interrupt to initiate a DMA transfer of the video bitstream from the GPU buffer to the memory of the DPU. Once the DMA transfer is complete, the DPU can notify the GPU that the DMA transfer is complete via an event or software callback. Once the DMA transfer is complete, the DPU can perform a network processing operation on the video bitstream in the memory of the DPU.

In at least one embodiment, the second PCIe device is a network device, such as a switch. The switch, also referred to as a “network switch,” is a network device that connects multiple devices within a local area network (LAN) (or virtual LANs (VLANs), allowing them to communicate with each other by forwarding data packets based on their destination media access control (MAC) addresses. VLANs can be configured on network switches to segment and isolate network traffic for different purposes, such as separating production and development environments. In data center environments, network switches provide high-speed, low-latency connectivity between servers, storage devices, and other networking equipment. In larger data center architectures, aggregation switches and core switches might be used to connect multiple racks of servers and provide connectivity to external networks. The switch can be a top-of-rack (TOR) switch commonly used in data center environments. The switch can connect servers and networking equipment within a rack and provide high-speed and low-latency connectivity. The switch can include a CPU, memory, port interfaces, and switching fabric. The switching fabric is responsible for forwarding data packets between different ports. The switching fabric can be made up of specialized integrated circuits and components that manage the data flow. The port interfaces are physical interfaces where devices, such as servers, storage devices, or other switches connect to the switch. The port interfaces can include Ethernet ports, fiber-optic connections, copper connections, or the like. The CPU and memory handle management tasks, control plane operations, and handle routing and switching protocols. The switch can execute software components, such as an operating system, switching and routing protocols (e.g., networking protocols such as Ethernet switching, IP routing, VLAN management, or the like), management interfaces (e.g., command line interfaces (CLI), web interfaces, or application programming interfaces (APIs) that allow network administrators to set up VLANs, configure ports, and monitor network performance), security features (access control lists (ACLs), port security, authentication, or the like), monitoring and reporting, and firmware.

In at least one embodiment, the PCIe devices are part of a computing system in a data center. The computing system can have multiple host devices and/or multiple VMs managed by a hypervisor or virtual machine manager (VMM). The network traffic at a switch, in particular TOR switches, is similar to network traffic as seen by a DPU.

In at least one embodiment, a host device includes a NIC, a hypervisor, and multiple VMs. The second PCIe can be the NIC of the host device. In at least one embodiment, the host devices include a DPU, a hypervisor, and multiple VMs. The second PCIe device is a DPU.

In at least one embodiment, the application 118 is a game application (also referred to as a game or a game seat), and the first PCIe device 102 is a GPU, and the second PCIe device 104 is a DPU (or other networking component), such as illustrated and described below with respect to FIG. 2.

FIG. 2 is a block diagram of an example DPU-based system architecture 200 with a hardware synchronization mechanism 116 for synchronizing DMA transfers of video bitstreams from a GPU-mapped system memory buffer to a memory of a DPU without involvement of a CPU, according to at least one embodiment. The DPU-based system architecture 200 (also referred to as “system” or “computing system” herein) includes a GPU 202, a DPU 204, and one or more CPUs 106. The GPU 202 can include or be coupled to GPU memory 210 (also referred to a video memory). The CPU 106 can be coupled to system memory 212. The CPU 206 can execute a game 216 to be streamed to a client device 222 over a network 208. The GPU 202 can render frames of the game 216 and encode a video bitstream of the rendered frames and store the video bitstream in a GPU-mapped system memory buffer. The GPU-mapped system memory buffer can be in GPU memory 210 or system memory 212. The DPU 204 includes DPU memory 214. The DPU memory 214 can be onboard memory or memory that is coupled directly to the DPU 204. The DPU 204 includes the hardware synchronization mechanism 116. The hardware synchronization mechanism 116 can synchronize DMA transfers of the video bitstream from the GPU-mapped system memory buffer to the DPU memory 214 of the DPU 204 without involvement of the CPU 206. The DPU 204 can send streaming data, including the video bitstream, to the client device 222 over the network 208.

In at least one embodiment, the DPU 204 include hardware engines and one or more processing cores (e.g., ARM cores) to perform network operations and encryption on the video bitstream and an audio bitstream and send the streaming data to the client device 222 over the network 208. The hardware engines and one or more processing cores can perform subsequent operations on the encoded bitstream after being encoded by the GPU 202. As described above, these subsequent operations were previously performed by a CPU, adding to latency waiting for the CPU to be available and taking away CPU resources that could otherwise be used for executing the game. Using the hardware synchronization mechanism 116, the DPU 204 can perform these subsequent operations, reducing the latency for streaming data and keeping CPU resources available for executing the game 216.

In at least one embodiment, the GPU 202 includes a GPU rendering engine 218 and a GPU encoding engine 220. The GPU rendering engine 218 can render the frames of the game 216. The GPU encoding engine 220 can encode the video bitstream into an encoded bitstream, store the encoded bitstream in the GPU-mapped system memory buffer, and output a completion indication to a semaphore memory accessible by the DPU 204. For example, a semaphore gets released by the GPU encoding engine 220 once the encoding is completed. The semaphore can be used to synchronize the DPU 204 initiating the DMA transfer as soon as the encoded bitstream is available for transfer to the DPU memory 214. In at least one embodiment, the hardware synchronization mechanism 116 can poll the semaphore memory periodically and determine a size for a DMA transfer of a portion of the video bitstream. For example, the hardware synchronization mechanism 116 can determine a status and size of the buffer, such as per frame size. In at least one embodiment, the GPU 202 can provide a mapping of the GPU-mapped system memory buffer to the DPU 204. The GPU encoding engine 220 can release a semaphore in a semaphore memory, accessible by both the GPU 202 and the DPU 204, upon completion of encoding a portion of the video bitstream. Once the semaphore is released, the DPU 204 can initiate a DMA transfer of the GPU-mapped system memory buffer to the DPU memory 214. In this manner, the DPU 204 can pick up processing of the video bitstream as soon as it is encoded by the GPU encoding engine 220 without waiting for the CPU 206.

In at least one embodiment, the GPU 202 can map a set of GPU-mapped system memory buffers to the DPU 204. The GPU 202 can map semaphore indexes of a semaphore memory to the DPU, each semaphore index identifying one of the plurality of GPU-mapped system memory buffers. The GPU 202 can store an encoded bitstream in the GPU-mapped system memory buffer. The GPU 202 can release a semaphore index associated with the GPU-mapped system memory buffer, the semaphore index identifying the GPU-mapped system memory buffer. The DPU 204 can poll the semaphore memory periodically. The DPU 204 can raise an interrupt to initiate a DMA transfer of a copy of the video bitstream in the GPU-mapped system memory buffer to the memory of the DPU 204. Once the DMA transfer is complete, the DPU 204 can notify the GPU that the DMA transfer is complete via an event or software callback. Once the DMA transfer is complete, the DPU 204 can perform network processing on the video bitstream in the memory of the DPU 204.

In at least one embodiment, the CPU 206 can capture an audio bitstream of the game 216 and send the audio bitstream to the DPU memory 214 of the DPU 204 using a communication channel between the CPU 206 and the DPU 204. This can be a separate communication channel than the synchronization mechanism used for the video bitstream.

In at least one embodiment, the GPU 202 can map the GPU-mapped system memory buffer to the DPU 204 and map a semaphore memory to the DPU 204. The DPU 204 can poll the semaphore memory periodically. The DPU 204 can raise an interrupt to initiate a DMA transfer of a copy of the video bitstream in the GPU-mapped system memory buffer to the DPU memory 214 of the DPU 204. Once the DMA transfer is complete, the DPU 204 can notify the GPU 202 that the DMA transfer is complete via an event or software callback. The GPU 202, once it receives notification that the DMA transfer is complete, the GPU-mapped system memory buffer can be put back into a queue of buffers to be used by the GPU encoding engine 220. Once the DMA transfer is complete, the DPU 204 can perform network processing on the video bitstream in the DPU memory 214 of the DPU 204.

In at least one embodiment, the DPU 204 is a first integrated circuit, the GPU 202 is a second integrated circuit, and the CPU 206 is a third integrated circuit. The GPU 202 (or additional GPUs), the DPU 204, and the one or more CPUs 206 can be part of a data center and include one or more data stores, one or more server machines, and other components of data center infrastructure. The DPU 204 can be coupled to the network 208. The network 208 may include a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, and/or a combination thereof.

In at least one embodiment, DPU 204 is integrated as a System on a Chip (SoC) that is considered a data center infrastructure on a chip. In at least one embodiment, DPU 204 includes DPU hardware and DPU software (e.g., software framework with acceleration libraries). The DPU hardware can include a CPU (e.g., a single-core or multi-core CPU), one or more hardware accelerators, memory, one or more host interfaces, and one or more network interfaces. The DPU hardware can also include multiple CPU cores (e.g., multiple ARM cores). The software framework and acceleration libraries can include one or more hardware-accelerated services, including hardware-accelerated security service (e.g., NVIDIA DOCA), hardware-accelerated virtualization services, hardware-accelerated networking services, hardware-accelerated storage services, hardware-accelerated artificial intelligence/machine learning (AI/ML) services, and hardware-accelerated management services. It should be noted that, unlike a CPU or a GPU, the DPU 204 is a new class of programmable processor that combines three key elements, including, for example: 1) an industry-standard, high-performance, software-programmable CPU (single-core or multi-core CPU), tightly coupled to the other SoC components; 2) a high-performance network interface capable of parsing, processing and efficiently transferring data at line rate, or the speed of the rest of the network, to GPUs and CPUs; and 3) a rich set of flexible and programmable acceleration engines that offload and improve applications performance for AI and machine learning, security, telecommunications, and storage, among others. These capabilities can enable an isolated, bare-metal, cloud-native computing platform for cloud-scale computing. In at least one embodiment, DPU 204 can be used as a stand-alone embedded processor. In at least one embodiment, DPU 204 can be incorporated into a network interface controller (also called a Smart Network Interface Card (SmartNIC)) used as a server system component. A DPU-based network interface card (network adapter) can offload processing tasks that the server system's CPU normally handles. Using its processor, a DPU-based SmartNIC may be able to perform any combination of encryption/decryption, firewall, transport control protocol/Internet Protocol (TCP/IP), and HyperText Transport Protocol (HTTP) processing. SmartNICs can be used for high-traffic web servers, for example.

In at least one embodiment, DPU 204 can be configured for traditional enterprises' modern cloud workloads and high-performance computing. In at least one embodiment, DPU 204 can deliver a set of software-defined networking, storage, security, and management services at a data-center scale with the ability to offload, accelerate, and isolate data center infrastructure. In at least one embodiment, DPU 204 can provide multi-tenant, cloud-native environments with these software services. In at least one embodiment, DPU 204 can deliver data center services of up to hundreds of CPU cores, freeing up valuable CPU cycles to run business-critical applications. In at least one embodiment, DPU 204 can be considered a new type of processor that is designed to process data center infrastructure software to offload and accelerate the compute load of virtualization, networking, storage, security, cloud-native AI/ML services, and other management services.

In at least one embodiment, DPU 204 can include connectivity with packet-based interconnects (e.g., Ethernet), switched-fabric interconnects (e.g., InfiniBand, Fibre Channels, Omni-Path), or the like. In at least one embodiment, DPU 204 can provide a data center that is accelerated, fully programmable, and configured with security (e.g., zero-trust security) to prevent data breaches and cyberattacks. In at least one embodiment, DPU 204 can include a network adapter, an array of processor cores, and infrastructure offload engines with full software programmability. In at least one embodiment, DPU 204 can sit at an edge of a server to provide flexible, secured, high-performance cloud and AI workloads. In at least one embodiment, DPU 204 can reduce the total cost of ownership and increase data center efficiency. In at least one embodiment, DPU 204 can provide the software framework and acceleration libraries (e.g., NVIDIA DOCA™) that enable developers to rapidly create applications and services for DPU 204, such as security services, virtualization services, networking services, storage services, AI/ML services, and management services.

In at least one embodiment, DPU 204 can provide networking services with a virtual switch (vSwitch), a virtual router (vRouter), network address translation (NAT), load balancing, and network virtualization (NFV). In at least one embodiment, DPU 204 can provide storage services, including NVME™ over fabrics (NVMe-oF™) technology, elastic storage virtualization, hyper-converged infrastructure (HCI) encryption, data integrity, compression, data deduplication, or the like. NVM Express™ is an open logical device interface specification for accessing non-volatile storage media attached via the PCI Express® (PCIe) interface. NVMe-oF™ provides an efficient mapping of NVMe commands to several network transport protocols, enabling one computer (an “initiator”) to access block-level storage devices attached to another computer (a “target”) very efficiently and with minimum latency. The term “Fabric” is a generalization of the more specific ideas of network and input/output (I/O) channel. It essentially refers to an N:M interconnection of elements, often in a peripheral context. The NVMe-oF™ technology enables the transport of the NVMe command set over a variety of interconnection infrastructures, including networks (e.g., Internet Protocol (IP)/Ethernet) and also I/O Channels (e.g., Fibre Channel). In at least one embodiment, DPU 204 can provide hardware-accelerated security services using Next-Generation Firewall (FGFW), Intrusion Detection Systems (IDS), Intrusion Prevention System (IPS), a root of trust, micro-segmentation, distributed denial-of-service (DDoS) prevention technologies, and ML detection. Next-Generation Firewall (NGFW) is a network security device that provides capabilities beyond a stateful firewall, like application awareness and control, integrated intrusion prevention, and cloud-delivered threat intelligence. In at least one embodiment, the one or more network interfaces can include an Ethernet interface (single or dual ports) and an InfiniBand interface (single or dual ports). In at least one embodiment, the one or more host interfaces can include a PCIe interface and a PCIe switch. In at least one embodiment, the one or more host interfaces can include other memory interfaces. In at least one embodiment, the CPU(s) of the DPU 204 can include multiple cores (e.g., up to 8 64-bit core pipelines) with L2 cache per two one or two cores and L3 cache with eviction policies support for double data rate (DDR) dual in-line memory module (DIMM) (e.g., DDR4 DIMM support), and a DDR4 DRAM controller. Memory can be on-board DDR4 memory with error correction code (ECC) error protection support. In at least one embodiment, the CPU can include a single core with L2 and L3 caches and a DRAM controller. In at least one embodiment, the one or more hardware accelerators can include a security accelerator, a storage accelerator, and a networking accelerator. In at least one embodiment, the security accelerator can provide a secure boot with hardware root-of-trust, secure firmware updates, Cerberus compliance, Regular expression (RegEx) acceleration, IP security (IPsec)/Transport Layer Security (TLS) data-in-motion encryption, AES-GCM 512/256-bit key for data-at-rest encryption (e.g., Advanced Encryption Standard (AES) with ciphertext stealing (XTS) (e.g., AES-XTS AES-XTS 256/512), secure hash algorithm (SHA) 256-bit hardware acceleration, Hardware public key accelerator (e.g., Rivest-Shamir-Adleman (RSA), Diffic-Hellman, Digital Signal Algorithm (DSA), ECC, Elliptic Curve Cryptography Digital Signal Algorithm (EC-DSA), Elliptic-curve Diffic-Hellman (EC-DH)), and True random number generator (TRNG). In at least one embodiment, the storage accelerator can provide BlueField SNAP-NVMe™ and VirtIO-blk, NVMe-oF™ acceleration, compression and decompression acceleration, and data hashing and deduplication. In at least one embodiment, the network accelerator can provide remote direct memory access (RDMA) over Converged Ethernet (ROCE) ROCE, Zero Touch ROCE, Stateless offloads for TCP, IP, and User Datagram Protocol (UDP), Large Receive Offload (LRO), Large Segment Offload (LSO), checksum, Total Sum of Squares (TSS), Residual Sum of Squares (RSS), HTTP dynamic streaming (HDS), and virtual local area network (VLAN) insertion/stripping, single root I/O virtualization (SR-IOV), virtual Ethernet card (e.g., VirtIO-net), Multi-function per port, VMware NetQueue support, Virtualization hierarchies, and ingress and egress Quality of Service (QOS) levels (e.g., 1K ingress and egress QoS levels). In at least one embodiment, DPU 204 can also provide boot options, including secure boot (RSA authenticated), remote boot over Ethernet, remote boot over Internet Small Computer System Interface (iSCSI), Preboot execution environment (PXE), and Unified Extensible Firmware Interface (UEFI).

In at least one embodiment, DPU 204 can provide management services, including a 1 GbE out-of-band management port, network controller sideband interface (NC-SI), Management Component Transport Protocol (MCTP) over System Management Bus (SMBus), and Monitoring Control Table (MCT) over PCIe, Platform Level Data Model (PLDM) for Monitor and Control, PLDM for Firmware Updates, Inter-Integrated Circuit (I2C) interface for device control and configuration, Serial Peripheral Interface (SPI) interface to flash, embedded multi-media card (cMMC) memory controller, Universal Asynchronous Receiver/Transmitter (UART), and Universal Serial Bus (USB).

Previously, users, devices, data, and applications inside the data center were implicitly trusted, and perimeter security was sufficient to protect them from external threats. In at least one embodiment, DPU 204, using hardware-accelerated security service, can define the security perimeter with a zero-trust protection model that recognizes that everyone and everything inside and outside the network cannot be trusted. Hardware-accelerated security service can enable network screening with encryption, granular access controls, and micro-segmentation on every host and for all network traffic. Hardware-accelerated security service can provide isolation, deploying security agents in a trusted domain separate from the host domain. If a host device is compromised, this isolation by hardware-accelerated security service prevents the attacker from knowing about or accessing hardware-accelerated security service, helping to prevent the attack from spreading to other servers. In at least one embodiment, the hardware-accelerated security service described herein can provide host monitoring, enabling cybersecurity vendors to create accelerated intrusion detection system (IDS) solutions to identify an attack on any physical or virtual machine. Hardware-accelerated security service can feed data about application status to a monitoring system. Hardware-accelerated security services can also provide enhanced forensic investigations and incident response.

The DPU-based system architecture 200 can be part of a host device or can host one or more virtual machines (VM) that emulate a host device. The host device may be a desktop computer, a laptop computer, a smartphone, a tablet computer, a server, or any suitable computing device capable of performing the techniques described herein. In some embodiments, the host device may be a computing device of a cloud-computing platform. For example, the host device may be a server machine of a cloud-computing platform or a component of the server machine. In such embodiments, the host device may be coupled to one or more edge devices, such as client device 222, via network 208. An edge device refers to a computing device that enables communication between computing devices at the boundary of two networks. For example, an edge device may be connected to a host device, one or more data stores, one or more server machines via network 208, and may be connected to one or more endpoint devices (not shown) via another network. In such an example, the DPU 204 can enable communication between the host device, one or more data stores, one or more server machines, and one or more client devices. In other or similar embodiments, the host device may be an edge device or a component of an edge device.

In still other or similar embodiments, the client device 222 can be an endpoint device or a component of an endpoint device. For example, client device 222 may be, or may be a component of, devices, such as televisions, smartphones, cellular telephones, data center servers, data DPUs, personal digital assistants (PDAs), portable media players, netbooks, laptop computers, electronic book readers, tablet computers, desktop computers, set-top boxes, gaming consoles, a computing device for autonomous vehicles, a surveillance device, and the like. In such embodiments, client device 222 may be connected to DPU 204 over one or more network interfaces via network 208. In other or similar embodiments, client device 222 may be connected to an edge device (not shown) via another network, and the edge device may be connected to DPU 204 via network 208.

In at least one embodiment, the host device executes one or more computer programs. One or more computer programs can be any process, routine, or code executed by the host device, such as a host OS, an application, a guest OS of a virtual machine, or a guest application, such as executed in a container. Host device can include one or more CPUs of one or more cores, one or more multi-core CPUs, one or more GPUs, one or more hardware accelerators, or the like.

In at least one embodiment, DPU 204 includes a DMA controller (not illustrated in FIG. 2) coupled to a host interface. The DMA controller can read the data from the host's physical memory via a host interface. The DMA controller can read the data from the GPU's physical memory. In at least one embodiment, the DMA controller reads data from the host's physical memory (or the GPU's physical memory) using the PCIe technology. Alternatively, other technologies can be used to read data from the host's physical memory.

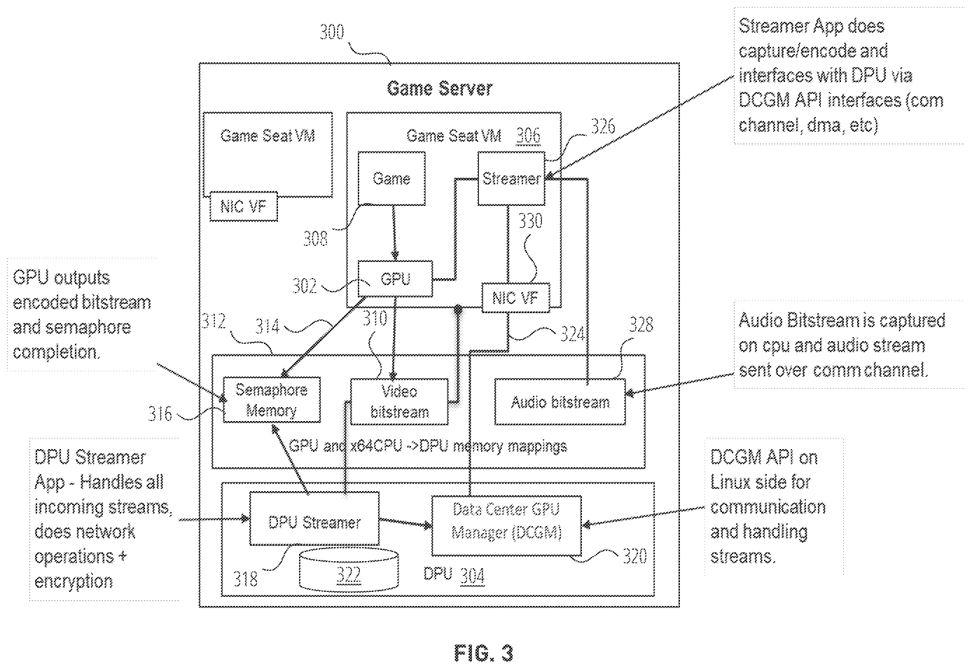

FIG. 3 is a block diagram of a game server 300 using a DPU 304 in a streaming pipeline for game streaming scenarios according to at least one embodiment. The game server 300 can include a streaming pipeline with a CPU (not illustrated in FIG. 3), the GPU 302, and the DPU 304. In the context of streaming games, a “game seat” identifies a license or a user slot designated for a specific payer in a cloud gaming or game streaming service. A game seat can also refer to a gaming session. There can be multiple game seats, such as in a multiplayer gaming experience that allow multiple users to access and play games via streaming. The game server 300 can allocate resources, such as a game seat virtual machine (VM) 306. The game seat VM 306 can execute a game 308 (e.g., game application, virtual reality (VR) or augmented reality (AR) application). The game 308 can be executed on a CPU and the GPU 302 can render frames of the game 308 and encode a video bitstream 310 of the rendered frames and store the video bitstream 310 in a GPU-mapped system memory buffer. The GPU-mapped system memory buffer can be one of multiple memory buffers in memory 312 of the game server 300. The memory buffers of the memory 312 can be mapped to the DPU 304. The GPU 202 can map memory buffers and semaphore memory to the DPU 304. That is, the GPU 302 can provide a mapping of the GPU-mapped system memory buffer to the DPU 304 (e.g., GPU and x64CPU->DPU memory mappings). The GPU 302 can use semaphore indexes to identify the memory buffer that the GPU 302 is using for the video bitstream 310, and a semaphore value or completion indication can be used to signal to the DPU 304 when the GPU 302 is completed with the video bitstream 310. In at least one embodiment, a GPU encoding engine of the GPU 302 can release a semaphore in the semaphore memory 316 corresponding to the video bitstream 310 when the video bitstream 310 is completed by the GPU encoding engine. The semaphore memory 316 and the GPU-mapped system memory buffer are accessible by both the GPU 302 and the DPU 304. It should be noted that the video bitstream 310 can be a portion of the overall bitstream from the game 308.

In the game streaming scenario, the GPU 302 handles game rendering and when the game 308 is to be streamed to a connecting client (not illustrated in FIG. 3), the game's rendered buffer in video is captured and then encoded on the GPU 302 using the GPU's encoding engine. Unlike solutions that make a copy of the encoded bitstream for further processing by the CPU of the game seat VM 306, the GPU 302 stores the encoded video bitstream 310 in memory that is accessible by (e.g., memory mapped to) the DPU 304 for further processing by the DPU 304 before streaming the video bitstream 310 to the connecting client.

As described above, the GPU 302 outputs the encoded bitstream and semaphore completion indication into memory 312, which is accessible by the DPU 304. The DPU 304 can include a DPU streamer 318 and a data center GPU manager (DCGM) 320. The DPU streamer 318 is an application executed by the DPU 304 that handles incoming streams, performs network and encryption operations, or the like. The DPU streamer 318 can be executed on one or more processing cores of the DPU 304. In at least one embodiment, the DPU 304 includes hardware engines and one or more processing cores to perform the network and encryption operations. The DPU 304 include onboard memory 322. The DPU streamer 318, upon determining that the semaphore completion indication is signaled by the GPU 302 in the semaphore memory 316, can initiate a DMA transfer of the video bitstream 310 to store the video bitstream 310 in onboard memory 322. The DPU streamer 318 can perform the additional operations, such as network and encryption operations, on the video bitstream 310 stored in the onboard memory 322. This can be used to free up the GPU-mapped system memory buffer for other video streams by the game seat VM 306 or other game seat VMs. The data center GPU manager 320 is a software framework or a software layer that can manage and monitor the GPU 302. The data center GPU manager 320 can provide tools and libraries to optimize, manage, and monitor performance, diagnostics, status, and health of the GPUs in the data center, including the GPU 302. The data center GPU manager 320 can track metrics such as temperature, power usage, memory usage, utilization rates, or the like. The data center GPU manager 320 can use the NVIDIA DOCA, developed by Nvidia Corporation, Santa Clara, California. The data center GPU manager 320 can use other GPU manager technologies.

As illustrated in FIG. 3, the data center GPU manager 320 can provide application programming interfaces (APIs) on the DPU side for communication and handling of streams between the GPU 302 and the DPU 304. The data center GPU manager 320 can establish a communication channel 324 with the game seat VM 306 for some communications and handling of streams of the game seat VM 306. In at least one embodiment, a GPU streamer 326 (e.g., streamer application) is an application executed by the GPU 302. The GPU streamer 326 can capture and encode the video bitstream 310. The GPU streamer 326 can interface with the DPU 304 via the APIs via APIs of the DPU 304, such as the DCGM API interfaces, the communication channel 324, DMA transfers, etc. In at least one embodiment, the GPU streamer 326 can communication with the data center GPU manager 320 over a network interface card (NIC) virtual function (VF) 330 and communication channel 324.

In at least one embodiment, an audio bitstream 328 can be captured by a CPU of the game seat VM 306. The audio bitstream 328 can be stored in memory 312 and send to the DPU 304 over the communication channel 324 established by the data center GPU manager 320. In at least one embodiment, the DPU streamer 318 can retrieve the audio bitstream 328. Similarly, a local copy of the audio bitstream 328 can be stored in the onboard memory 322 for subsequent processing with the video bitstream 310. The DPU streamer 318 can perform network operations and encryption operations on the video bitstream 310 and the audio bitstream 328 to obtain streaming data. The DPU 304 sends the streaming data to the connecting client over the network (not illustrated in FIG. 3).

As described herein, in game streaming scenarios, typically the driver and lower-level components make a copy of the encoded bitstream from video memory into system memory and then the resulting compressed bitstream is then processed by the CPU before being sent to the client. This causes latency waiting for the CPU for the subsequent processing after the rendering and encoding by the GPU. Also, the subsequent processing uses additional computing resources by the CPU, which can be better used for the game. Also, with a virtualized GPU, the GPU resources can be used by multiple streams. All of these streams would then need to run on the network stack of the CPU, causing bottlenecks and additional latency. In extreme scenarios, where lot of streams are being run on a virtualized CPU and GPU, scheduling issues can arise for an operating system (OS) thread scheduling these operations, causing disruptions in streaming the game and/or QoS problems. By using the DPU 304 for streaming the game, these latencies and problems can be avoided or reduced.

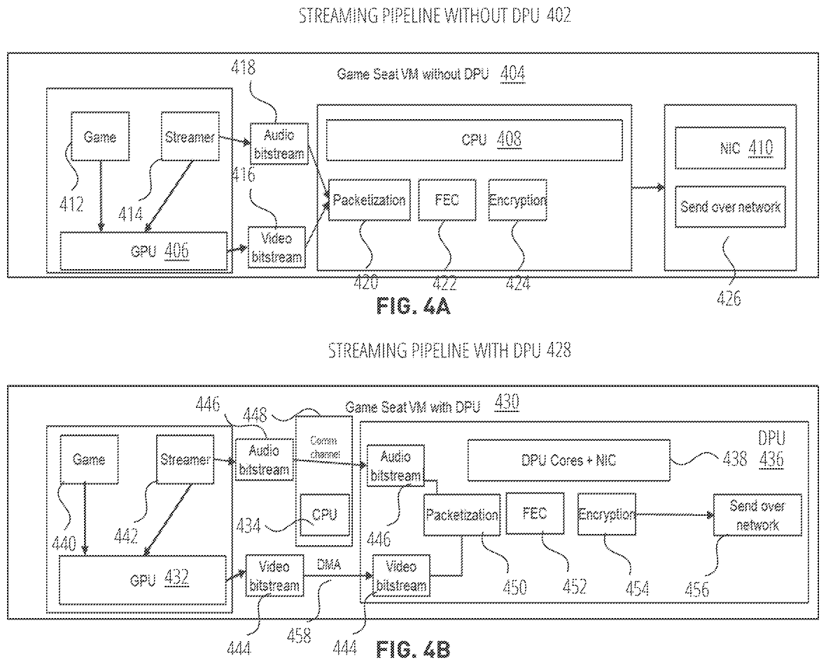

FIG. 4A is a block diagram of a streaming pipeline 402 without a DPU according to at least one embodiment. The streaming pipeline 402, as illustrated in FIG. 4A, can be implemented in a game seat VM 404. The game seat VM 404 can include a GPU 406, a CPU 408, and a NIC 410. These can be virtualized components. The GPU 406 can render frames of a game 412 being executed by the CPU 408. That is, the CPU 408 executes the game 412, but offloads rendering frames and encoding the video bitstream to the GPU 406 as represented by the game 412. The GPU 406 also executes a streamer 414 to handle streams being processed by the GPU 406. The GPU 406 outputs a video bitstream 416 to the CPU 408 and the streamer 414 outputs an audio bitstream to the CPU 408. Typically, the GPU 406 can have a GPU buffer in which is stores the video bitstream. After completion, a driver or a lower-level component can make a copy of the video bitstream in the GPU buffer to system memory accessible by the CPU 408. The CPU 408 can perform additional operations on the copies of video bitstream 416 and audio bitstream 418 before sending to a client device over a network. The CPU 408 performs some network operations, such as packetization 420, forward error correction (FEC) 422, and encryption operations 424 on the streaming data. The CPU 408 provides the streaming data to the NIC 410 for sending the streaming data to the client device over the network 426. In other implementation, a DPU can be used instead of the NIC 410, but in this case, the packetization 420, FEC 422, and encryption operations 424 are performed by the CPU 408.

FIG. 4B is a block diagram of a streaming pipeline 428 with a DPU according to at least one embodiment. The streaming pipeline 428, as illustrated in FIG. 4B, can be implemented in a game seat VM 430. The game seat VM 430 can include a GPU 432, a CPU 434, and a DPU 436. These can be virtualized components. The DPU 436 can include DPU cores and NIC 438. The DPU cores can be used to perform packetization 450, FEC 452, and encryption operations 454, instead of the CPU 434. Alternatively, hardware engines of the DPU 436 can perform these operations. The GPU 432 can render frames of a game 440 being executed by the CPU 434. That is, the CPU 434 executes the game 440, but offloads rendering frames and encoding the video bitstream to the GPU 432 as represented by the game 440. The GPU 432 also executes a streamer 442 to handle streams being processed by the GPU 432. The GPU 432 outputs a video bitstream 444 to the DPU 436 using hardware synchronization mechanisms with one or more DMA transfer(s) 458 as described herein. In at least one embodiment, the CPU 434 can capture an audio bitstream 446 of the game 440 and store the audio bitstream 446 in system memory. The CPU 434 can provide the audio bitstream 446 to the DPU 436 using a communication channel 448 between the CPU 434 and the DPU 436. In at least one embodiment, the streamer 442 can coordinate with the CPU 434 to capture the audio bitstream 446 and provide it to the DPU 436 via the communication channel 448 between the CPU 434 and the DPU 436.

As described above, the DPU 436 can have DPU buffers in which it stores the video bitstream. The GPU buffers can be stored in video memory or system memory. Instead of making the video bitstream 444 accessible to the CPU 434, the GPU 432 makes the video bitstream 444 accessible to the DPU 436 using DMA transfers. The GPU buffers can be mapped to the DPU 436 using a memory mapping. That is, the GPU rendering engine and GPU encoding engine can store the video bitstream 444 in memory that is mapped to the DPU 436. Instead of making a copy of the video bitstream 444, the GPU 432 and DPU 436 can transfer the video bitstream 444 from the DPU buffers into onboard memory of the DPU 436 using one or more DMA transfer(s) 458 without involvement by the CPU 434. Instead of the CPU 434, the DPU 436 can perform additional operations on the video bitstream 444 and audio bitstream 446 before sending to a client device over a network. The DPU 436 (e.g., DPU cores and NIC 438) performs some network operations, such as packetization 450, FEC 452, and encryption operations 454 on the streaming data. The DPU 436, using the NIC functionality of the DPU 436), sends the streaming data to the client device over the network 456. In other embodiments, the DPU 436 or DPU cores and NIC 438 can perform other operations than packetization 450, FEC 452, and encryption operations 454.

Although illustrated as being part of the game seat VM 430, the streaming pipeline 428 can be implemented in a non-virtualized environment where the GPU 432, CPU 434, and DPU 436 are not virtualized. In other cases, some of the components are virtualized and some components are not virtualized. For example, in one implementation, the GPU 432 and the CPU 434 are virtualized and the DPU 436 is not virtualized.

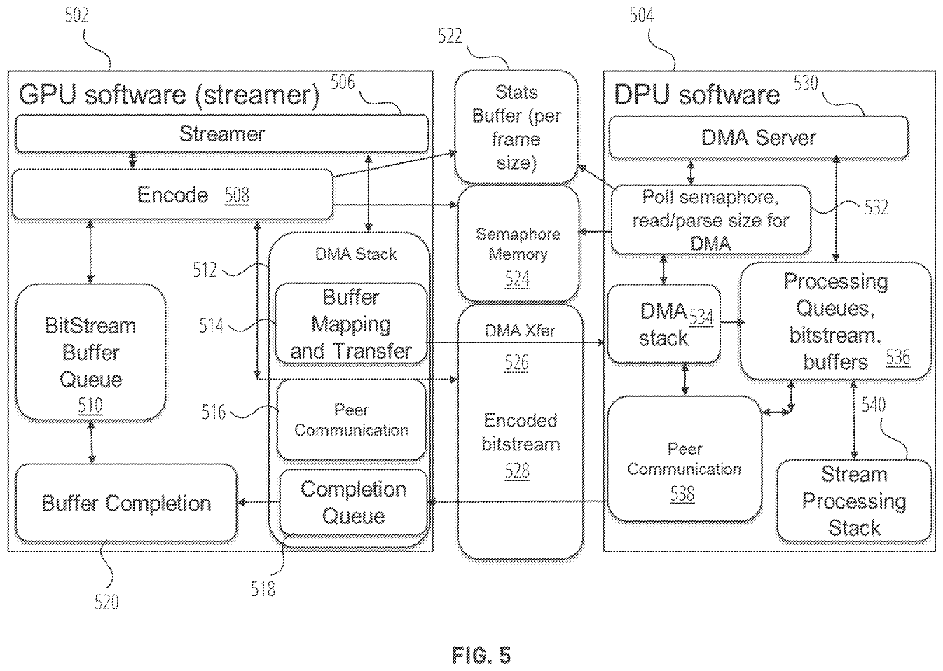

FIG. 5 is a block diagram of GPU software 502 and DPU software 504 for synchronizing streaming data according to at least one embodiment. The GPU software 502 can be executed by a GPU. The DPU software 504 can be executed by a DPU. The GPU software 502 can include a streamer 506, a GPU encoding engine 508, a bitstream buffer queue 510, and a DMA stack 512. The streamer 506 can capture video of a game (or other data to be streamed) and the GPU encoding engine 508 can encode a video bitstream and store it in a memory buffer from the bitstream buffer queue 510. The streamer 506 and GPU encoding engine 508 can interface with the DPU software 504 via APIs, such as the DCGM API interfaces, a communication channel, and DMA transfers 526, using a DMA stack 512. The DMA stack 512 can transfer the video bitstream using DMA transfer 526 as encoded bitstream 528. DMA is a method by which data can be transferred to and from memory without the continuous involvement of a CPU. This approach significantly improves data transfer speeds and overall system efficiency by freeing the CPU from handling these data transfers, allowing it to perform other tasks. The DMA stack 512 can include operations to handle buffer mapping and transfers 514 of the encoded bitstream 528. The GPU encoding engine 508 can also store a semaphore memory 524 upon completion of encoding frames of the game. The semaphore memory 524 can indicate that the DPU software 504 can initiate one or more DMA transfer 526 to transfer the encoded bitstream 528 to onboard memory of the DPU. The GPU encoding engine 508 can also store stats buffer 522 (e.g., per frame size) to help facilitate the DMA transfers 526 to the DPU.

The DPU software 504 includes a DMA server 530, a DMA stack 534, processing queues, bitstream, buffers 536, and a stream processing stack 540. The DMA server 530 can poll the semaphore memory 524, read or parse the size of the DMA transfers 526 using the stats buffer 522 (block 532). If the semaphore memory 524 is received, the DMA stack 534 can initiate the one or more DMA transfers 526. The DMA stack 534 can receive the encoded bitstream 528 via the one or more DMA transfers 526. The DMA stack 534 can store the encoded bitstream 528 in the processing queues, bitstream, buffers 536 of the DPU. Once the DMA transfer 526 is completed, the DPU software 504 can perform peer communications 538 with the DMA stack 512 of the GPU software 502 to send a completion indication. The DMA stack 512 can perform peer communications 516 to receive the completion indication from the DPU software 504 and store the completion indication in a completion queue 518. The GPU software 502 can perform operations at buffer completion block 520 to determine which buffer is completed and release the memory buffer in the bitstream buffer queue 510. A stream processing stack 540 can receive the encoded bitstream 528 from the processing queues, bitstream, buffers 536 for subsequent processing, such as network operations, encryption operations, or the like, as described herein.

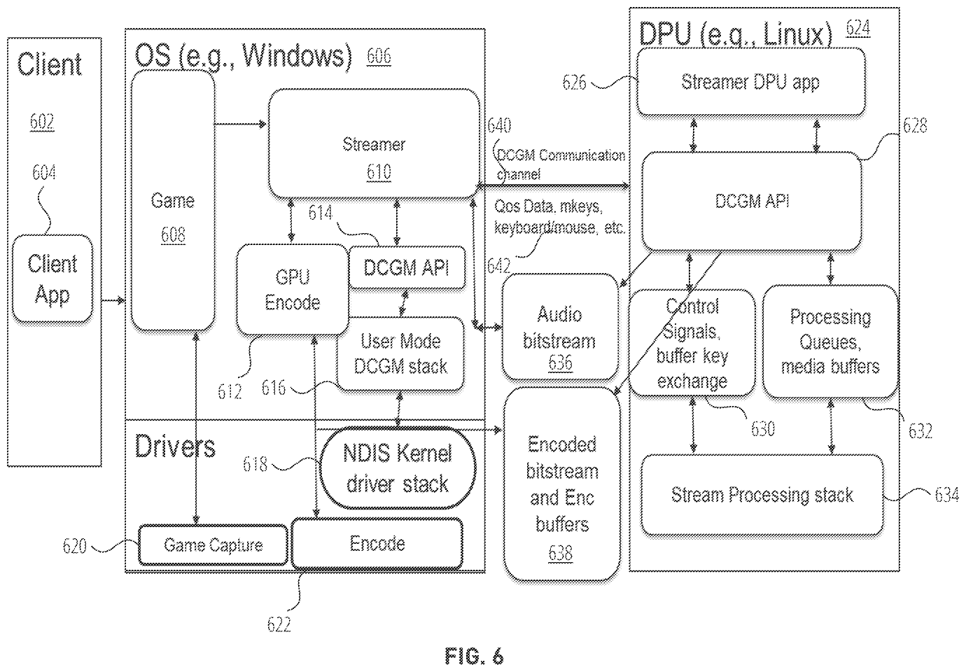

FIG. 6 is a block diagram of software of a client 602, an OS 606 of a VM, and DPU software 624 according to at least one embodiment. The client 602 executes a client application 604. The VM can execute an OS (e.g., Microsoft Windows), a game 608, a streamer 610, a GPU encoding engine 612, and a user mode DCGM stack 616. The user mode DCGM stack 616 can allow the streamer 610 to interact with a Network Driver Interface Specification (NDIS) kernel driver stack 618 using a DCGM API 614. The game 608 can use a game capture driver 620 to capture and render video frames of the game 608. The GPU encoding engine 612 can use an encode driver 622 to encode the video frames into an encoded bitstream 638 in encoder buffers. The streamer 610 can capture and store an audio bitstream 636 of the game 608 in memory. The DPU software 624 can include a DPU streamer 626 (labeled Streamer DPU app) that uses a DCGM API 628 to retrieve the audio bitstream 636 and the encoded bitstream 638 from the encoder buffers and store them in processing queues, media GPU buffers 632 of the DPU. The data in the processing queues, media GPU buffers 632 can be used by the stream processing stack 634. The stream processing stack 634 can perform control signals, buffer key exchange (block 630) with the DCGM API 628. The DCGM API 628 can also establish a DCGM communication channel 640 with the streamer 610. The streamer 610 can provide the audio bitstream 636 to the DPU software 624 via the DCGM communication channel 640. The streamer 610 can also provide other data, such as QoS data, management keys (mkeys), input data (e.g., keyboard/mouse), etc., to the DPU software 624.

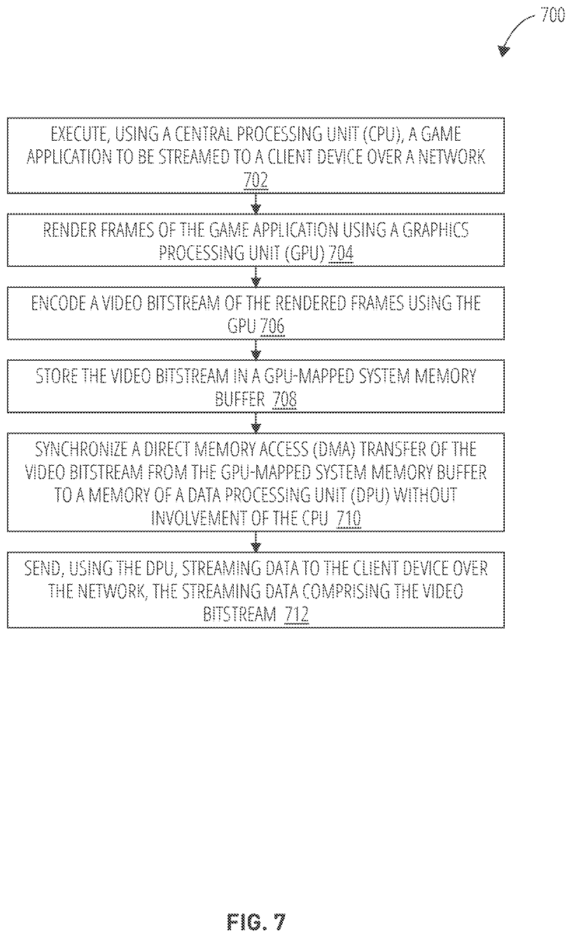

FIG. 7 is a flow diagram of an example method 700 of streaming game data using a DPU according to at least one embodiment. The processing logic can be a combination of hardware, firmware, software, or any combination thereof. In at least one embodiment, method 700 may be performed by processing logic of the computing system 100 of FIG. 1. In at least one embodiment, method 700 may be performed by processing logic of a CPU, a GPU, and a DPU. The method 700 may be performed by one or more data processing units (e.g., DPUs, CPUs, and/or GPUs), including (or communicating with) one or more memory devices. In at least one embodiment, method 700 may be performed by multiple processing threads, each thread executing one or more individual functions, routines, subroutines, or operations of the method. In at least one embodiment, processing threads implementing method 700 may be synchronized (e.g., using semaphores, critical sections, and/or other thread synchronization logic). Alternatively, processing threads implementing method 700 may be executed asynchronously with respect to each other. Various operations of method 700 may be performed differently than the order shown in FIG. 7. Some operations of the methods may be performed concurrently with other operations. In at least one embodiment, one or more operations shown in FIG. 7 may not always be performed.

Referring to FIG. 7, the processing logic begins with the processing logic (e.g., CPU) executing a game application to be streamed to a client device over a network. At block 704, the processing logic (e.g., GPU) renders frames of the game application. At block 706, the processing logic (e.g., GPU) encodes a video bitstream of the rendered frames. At block 708, the processing logic (e.g., GPU) stores the video bitstream in a GPU-mapped system memory buffer. At block 710, the processing logic (e.g., GPU/DPU) synchronizes a DMA transfer of the video bitstream from the GPU-mapped system memory buffer to a memory of a DPU without involvement of the CPU. At block 712, the processing logic (e.g., DPU s) sends streaming data to the client device over the network. The streaming data includes the video bitstream. The method 700 can include other operations as described herein.

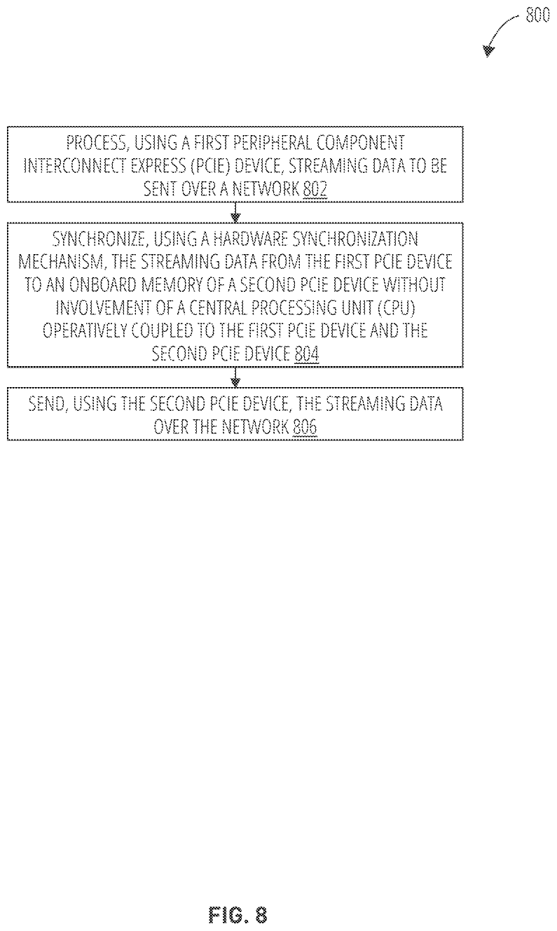

FIG. 8 is a flow diagram of an example method 800 of streaming data between a first PCIe device and a second PCIe device according to at least one embodiment. The processing logic can be a combination of hardware, firmware, software, or any combination thereof. In at least one embodiment, method 800 may be performed by processing logic of the computing system 100 of FIG. 1. In at least one embodiment, method 800 may be performed by processing logic of a first PCIe device and a second PCIE device. The method 800 may be performed by one or more data processing units (e.g., DPUs, CPUs, and/or GPUs), including (or communicating with) one or more memory devices. In at least one embodiment, method 800 may be performed by multiple processing threads, each thread executing one or more individual functions, routines, subroutines, or operations of the method. In at least one embodiment, processing threads implementing method 800 may be synchronized (e.g., using semaphores, critical sections, and/or other thread synchronization logic). Alternatively, processing threads implementing method 800 may be executed asynchronously with respect to each other. Various operations of method 800 may be performed differently than the order shown in FIG. 8. Some operations of the methods may be performed concurrently with other operations. In at least one embodiment, one or more operations shown in FIG. 8 may not always be performed.

Referring to FIG. 8, the processing logic begins with the processing logic (e.g., first PCIe device) processing streaming data to be sent over a network. At block 804, the processing logic (e.g., hardware synchronization mechanism) synchronizes the streaming data from the first PCIe device to an onboard memory of a second PCIe device without involvement of a CPU operatively coupled to the first PCIe device and the second PCIe device. At block 806, the processing logic (e.g., second PCIe device) sends the streaming data over the network. The method 800 can include other operations as described herein.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors—for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still co-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably insofar as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or interprocess communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system comprising:
a central processing unit (CPU) to execute a game application to be streamed to a client device over a network;
a graphics processing unit (GPU) to render frames of the game application and encode a video bitstream of the rendered frames and store the video bitstream in a GPU-mapped system memory buffer; and
a data processing unit (DPU) coupled to the CPU and the GPU, the DPU comprising memory and a hardware synchronization mechanism to synchronize direct memory access (DMA) transfers of the video bitstream from the GPU-mapped system memory buffer to the memory of the DPU without involvement of the CPU, wherein the DPU is to send streaming data to the client device over the network, the streaming data comprising the video bitstream.

2. The computing system of claim 1, wherein the DPU further comprises hardware engines and one or more processing cores to perform network operations and encryption on the video bitstream and an audio bitstream and send the streaming data to the client device over the network.

3. The computing system of claim 1, wherein the GPU comprises a GPU rendering engine and a GPU encoding engine, wherein the GPU rendering engine is to render the frames of the game application, and wherein the GPU encoding engine is to encode the video bitstream into an encoded bitstream, store the encoded bitstream in the GPU-mapped system memory buffer, and output a completion indication to a semaphore memory.

4. The computing system of claim 3, wherein the DPU is to poll the semaphore memory periodically and determine a size for a DMA transfer of a portion of the video bitstream.

5. The computing system of claim 1, wherein the CPU is to capture an audio bitstream of the game application and send the audio bitstream to the memory of the DPU using a communication channel between the CPU and the GPU.

6. The computing system of claim 1, wherein the GPU is to provide a mapping of the GPU-mapped system memory buffer to the DPU, and wherein a GPU encoding engine of the GPU is to release a semaphore in a semaphore memory, accessible by both the GPU and the DPU, upon completion of encoding a portion of the video bitstream.

7. The computing system of claim 1, wherein:
the GPU is to:
map a plurality of GPU-mapped system memory buffers to the DPU;
map semaphore indexes of a semaphore memory to the DPU, each semaphore index identifying one of the plurality of GPU-mapped system memory buffers;
store an encoded bitstream in the GPU-mapped system memory buffer; and
release a semaphore index associated with the GPU-mapped system memory buffer, the semaphore index identifying the GPU-mapped system memory buffer; and
the DPU is to:
poll the semaphore memory periodically;
raise an interrupt to initiate a DMA transfer of a copy of the video bitstream in the GPU-mapped system memory buffer to the memory of the DPU;
once the DMA transfer is complete, notify the GPU that the DMA transfer is complete via an event or software callback; and
once the DMA transfer is complete, perform network processing on the video bitstream in the memory of the DPU.

8. A computing system comprising:
a central processing unit (CPU);
a first Peripheral Component Interconnect Express (PCIe) device coupled to the CPU;
a second PCIe device coupled to the CPU and the first PCIe device; and
a hardware synchronization mechanism to synchronize streaming data from the first PCIe device to the second PCIe device without involvement by the CPU.

9. The computing system of claim 8, wherein the first PCIe device is a graphics processing unit (GPU), wherein the second PCIe device is a data processing unit (DPU), wherein the DPU is a programmable data center infrastructure on a chip, and wherein the data is an encoded bitstream associated with a game executed by the CPU.

10. The computing system of claim 8, wherein:
the first PCIe device is to store the streaming data in a system memory buffer, map the system memory buffer to the second PCIe device, and map a semaphore memory to the second PCIe device; and
the second PCIe device is to initiate a direct memory access (DMA) transfer to store a copy of the streaming data in memory of the second PCIe device without involvement of the CPU.

11. The computing system of claim 10, wherein the second PCIe device is to send the streaming data to a client device over a network.

12. The computing system of claim 8, wherein:
the first PCIe device is to:
map a system memory buffer to the second PCIe device; and
map a semaphore memory to the second PCIe device; and
the second PCIe device is to:
poll the semaphore memory periodically;
raise an interrupt to initiate a DMA transfer of the streaming data from the system memory buffer to a memory of the second PCIe device; and
once the DMA transfer is complete, notify the first PCIe device that the DMA transfer is complete via an event or software callback.

13. The computing system of claim 12, wherein the second PCIe device is further to perform an operation on the streaming data in the memory of the second PCIe device.

14. A first Peripheral Component Interconnect Express (PCIe) device comprising:
memory;
a central processing unit (CPU) operatively coupled to a first interface, a second interface, and a third interface, the first interface to couple to a host device, a second interface to couple to a second PCIe device, and the third interface to couple to a network; and
a hardware synchronization mechanism, wherein the hardware synchronization mechanism is to synchronize streaming data from the second PCIe device to the memory over the second interface without involvement by the host device.

15. The first PCIe device of claim 14, wherein the first PCIe device is a DPU, and the second PCIe device is a graphics processing unit (GPU), wherein:
the DPU is to initiate a direct memory access (DMA) transfer of a copy of a video bitstream stored in a GPU-mapped system memory buffer to the memory;
perform network operations and encryption on the video bitstream and an audio bitstream; and
send the streaming data to a client device over the network.

16. The first PCIe device of claim 15, wherein the DPU further comprises hardware engines and one or more processing cores to perform network operations and encryption on the video bitstream and an audio bitstream and send the streaming data to the client device over the network.

17. The first PCIe device of claim 15, wherein the GPU comprises a GPU encoding engine, the GPU encoding engine to encode the video bitstream and store the encoded bitstream in the GPU-mapped system memory buffer and output a completion indication to a semaphore memory.

18. The first PCIe device of claim 17, wherein the DPU is to poll the semaphore memory periodically and determine a size for a DMA transfer of a portion of the video bitstream.

19. The first PCIe device of claim 14, wherein the first PCIe device is a DPU, and the second PCIe device is a graphics processing unit (GPU), wherein:
the GPU is to:
store a video bitstream in a GPU buffer mapped to the DPU; and
map a semaphore memory to the DPU;
the DPU is to:
poll the semaphore memory periodically;
raise an interrupt to initiate a direct memory access (DMA) transfer of the video bitstream from the GPU buffer to the memory of the DPU;
once the DMA transfer is complete, notify the GPU that the DMA transfer is complete via an event or software callback; and
once the DMA transfer is complete, perform a network processing operation on the video bitstream in the memory of the DPU.

20. The first PCIe device of claim 14, wherein the first PCIe device is at least one of a data processing unit (DPU), a network interface card (NIC), or a switch, wherein the DPU is a programmable data center infrastructure on a chip.
